(19) United States
(12) Patent Application Publication
(10) Pub. No.: US 2009/0035646 A1
(43) Pub. Date: Feb. 5, 2009

(54) Swelling inhibition in batteries

(75) Inventors: Yuriy V. Mikhaylik, Tucson, AZ (US); Igor Kovalev, Tucson, AZ (US)

Correspondence Address: WOLF GREENFIELD & SACKS, P.C., 600 ATLANTIC AVENUE, BOSTON, MA, 02210-2206, US

(73) Assignee: Sion Power Corporation, Tucson, AZ (US)

(21) Appl. No.: 11/888,339

(22) Filed: Jul. 31, 2007

(51) Int. Cl. H01M 6/14

(52) U.S. Cl. 429/50; 429/163; 429/188

(57) ABSTRACT

The present invention relates generally to electrochemical cells, and more specifically, to additives for electrochemical cells which may enhance the performance of the cell. In some cases, the additive may advantageously interact with at least one component or species of the cell to increase the efficiency and/or lifetime of the cell. The incorporation of certain additives within the electrolyte of the cell may improve the cycling lifetime and/or performance of the cell.

### FIELD OF THE INVENTION

The invention generally relates to electrochemical cells, additives for electrochemical cells, and related methods.

### BACKGROUND OF THE INVENTION

A typical electrochemical cell has a cathode and an anode which participate in an electrochemical reaction. Some electrochemical cells (e.g., rechargeable batteries) may undergo a charge/discharge cycle involving deposition of metal (e.g., lithium metal) on the surface of the anode and reaction of the metal on the anode surface, wherein the metal diffuses from the anode surface. The efficiency and uniformity of such processes can be vital to efficient functioning of the electrochemical cell. In some cases, one or more electrodes may increase in size (e.g., swell) as the electrochemical cell undergoes repeated charge/discharge cycles, often due to formation and/or accumulation of impurities on the surface of an electrode. Such swelling can result in increasingly poor cell performance and may require that the electrochemical cells be placed in relatively large and bulky housing compartments to accommodate for swelling.

Accordingly, improved materials and methods are needed.

### SUMMARY OF THE INVENTION

The present invention relates to electrochemical cells comprising an anode comprising lithium; a cathode; and a non-aqueous electrolyte comprising at least one additive selected from the group consisting of six-membered aromatic rings comprising at least one nitrogen atom, excluding pyridine and pyridinium nitrate; six-membered aromatic rings comprising two nitrogen atoms; aromatic compounds comprising at least one alkoxy group or an optionally substituted alkyl group; substituted alkenes; substituted alkynes; and compounds comprising at least two, fused aromatic rings, optionally substituted.

The present invention also relates to electrochemical devices comprising an electrochemical cell, comprising an anode comprising lithium, a cathode, and a non-aqueous electrolyte comprising at least one additive selected from the group consisting of six-membered aromatic rings comprising at least one nitrogen atom, excluding pyridine and pyridinium nitrate; six-membered aromatic rings comprising two nitrogen atoms; aromatic compounds comprising at least one alkoxy group or an optionally substituted alkyl group; substituted alkenes; substituted alkynes; and compounds comprising at least two, fused aromatic rings, optionally substituted, wherein the electrochemical cell swells as a result of repeated charge and discharge of the cell, said swelling having a maximum swelling along a dimension of the electrochemical cell; and a housing compartment for the electrochemical cell, wherein the housing compartment is less than 10% larger in size than the electrochemical cell in the dimension of the electrochemical cell.

The present invention also provides methods comprising providing an electrochemical cell comprising an anode with lithium as the active anode material, a cathode, and a non-aqueous electrolyte in electrochemical communication with the anode and cathode, wherein the electrolyte comprises at least one additive selected from the group consisting of six-membered aromatic rings comprising at least one nitrogen atom, excluding pyridine and pyridinium nitrate; six-membered aromatic rings comprising two nitrogen atoms; aromatic compounds comprising at least one alkoxy group or an optionally substituted alkyl group; substituted alkenes; substituted alkynes; and compounds comprising at least two, fused aromatic rings, optionally substituted; and cycling the cell, by alternatively discharging and charging the cell, at least fifty times wherein, at the end of the 40^{th} cycle, the size of the cell increases by less than 20% as compared to an essentially identical cell over an essentially identical set of charge/discharge cycle absent the additive.

### BRIEF DESCRIPTION OF THE DRAWINGS

FIG. 1 shows an electrochemical cell, according to one embodiment of the invention.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

The present invention relates generally to electrochemical cells, and more specifically, to additives for electrochemical cells. In particular, additives that may reduce swelling of an electrode are presented.

The present invention relates to the incorporation of additives into one or more components of an electrochemical cell, which may enhance the performance of the cell.

In some cases, an additive such as an organic compound may be incorporated into the electrolyte and may advantageously interact with at least one component or species of the cell to increase the efficiency and/or lifetime of the cell. For example, electrochemical cells (e.g., rechargeable batteries) may undergo a charge/discharge cycle involving deposition of metal (e.g., lithium metal) on the surface of the anode upon charging and reaction of the metal on the anode surface, wherein the metal diffuses from the anode surface, upon discharging. The efficiency and uniformity of such processes may affect cell performance. For example, lithium metal may interact with one or more species of the electrolyte to cause thickening or swelling of a component of the cell, such as an anode, resulting in decreased cycling lifetime and/or poor cell performance. The incorporation of certain additives within the electrolyte of the cell have been found, in accordance with the invention, to reduce such interactions and to improve the cycling lifetime and/or performance of the cell.

One aspect of the invention is the discovery that additives, such as organic additives, may reduce or prevent formation of lithium metal, impurities, or other species that may form on the surface of an electrode (e.g., anode), such that the cell may efficiently undergo charge-discharge cycling. Incorporation of such additives within electrochemical devices may reduce swelling of electrodes and may improve overall cell performance.

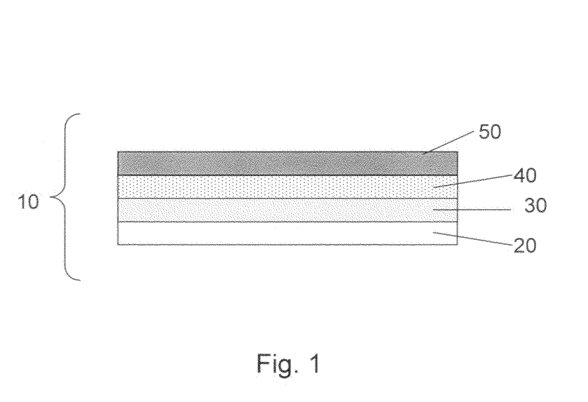

Although the present invention can find use in a wide variety of electrochemical devices, an example of one such device is provided in FIG. 1 for illustrative purposes only. In FIG. 1, a general embodiment of an electrochemical cell can include a cathode, an anode, and an electrolyte layer in contact with both electrodes. The components may be assembled such that the electrolyte is placed between the cathode and anode in a stacked configuration. FIG. 1 illustrates an electrochemical cell of the invention. In the embodiment shown, cell 10 includes a cathode 30 that can be formed on a substantially planar surface of substrate 20. A porous separator material 40 can be formed adjacent to the cathode 30 and can be deposited into the cathode 30. An anode layer 50 can be formed adjacent porous separator material 40 and may be in electrical communication with the cathode 30. The anode 50 may also be formed on an electrolyte layer positioned on cathode 30. Of course, the orientation of the components can be varied and it should be understood that there are other embodiments in which the orientation of the layers is varied such that, for example, the anode layer or the electrolyte layer is first formed on the substrate. Optionally, additional layers (not shown), such as a multi-layer structure that protects an electroactive material (e.g., an electrode) from the electrolyte, may be present, as described in more detail in U.S. patent application Ser. No. 11/400,781, filed Apr. 6, 2006, entitled, “Rechargeable Lithium/Water, Lithium/Air Batteries” to Affinito et al., which is incorporated herein by reference in its entirety. Additionally, non-planar arrangements, arrangements with proportions of materials different than those shown, and other alternative arrangements are useful in connection with the present invention. A typical electrochemical cell also would include, of course, current collectors, external circuitry, housing structure, and the like. Those of ordinary skill in the art are well aware of the many arrangements that can be utilized with the general schematic arrangement as shown in FIG. 1 and described herein.

As mentioned above, in some embodiments, the present invention relates to electrochemical devices comprising at least one additive. In some embodiments, the electrolyte may comprise the additive. However, other components of the electrochemical device may comprise the additive as well. In some embodiments, the present invention relates to electrochemical devices comprising an anode comprising lithium, a cathode, and an electrolyte (e.g., a non-aqueous electrolyte) comprising at least one additive. The additive may be any species, or salt thereof, capable of reducing swelling of electrodes within a cell, for example, by reducing formation of impurities within the cell, and/or by reducing deposition of impurities on the surface of the electrodes. In some embodiments, the additive may be an organic small molecule, a polymer, salts thereof, or combinations thereof. In some embodiments, the additive may be a neutral species. In some embodiments, the additive may be a charged species.

The additive may be present within (e.g., added to) the electrochemical cell in an amount sufficient to inhibit swelling in the cell. “An amount sufficient to inhibit swelling in the cell,” in this context, means that the additive is present in a large enough amount to affect (e.g., reduce) the swelling of one or more components of the cell, relative to an essentially identical cell lacking the additive. For example, trace amounts of an additive may not be sufficient to inhibit swelling in the cell. Those of ordinary skill in the art may determine whether an additive is present in an amount sufficient to affect swelling within an electrochemical device. For example, the additive may be incorporated within a component of an electrochemical cell, such as the electrolyte, and the electrochemical cell may be monitored over a number of charge/discharge cycles to observe any changes in cell thickness. Determination of the amount of change in cell thickness over a number of charge/discharge cycles may determine whether or not the additive is present in an amount sufficient to inhibit swelling. In some cases, the additive may be added to the electrochemical cell in an amount sufficient to inhibit swelling in the cell by at least 10%, at least 25%, at least 50%, at least 75%, or, in some cases, by 100%, over 50 charge/discharge cycles of the cell, as compared to swelling of an essentially identical cell over an essentially identical set of charge/discharge cycles, absent the additive.

In an illustrative embodiment, the additive may be present within the electrolyte in an amount between 1-30 wt %, between 2-20 wt %, or, in some cases, between 2-10 wt %, of the electrolyte.

Although not wishing to be bound by any theory, the inventors of the present invention offer the following discussion of the relationship between the presence of the additive and performance characteristics observed. In typical lithium anode batteries, after a few charge/discharge cycles of a battery, adverse changes of the anode can occur, such as swelling of the anode. This may be due to interaction of lithium with one or more species in the electrolyte to form an impurity, which can deposit on the surface of the anode at a higher volume than Li metal to cause swelling of the anode. In some cases, formation of the impurity may comprise interaction between lithium and a solvent present within the electrochemical cell, wherein the solvent decomposes to produce an impurity. In some cases, formation of the impurity may comprise interaction between lithium and a species comprising a proton. Additives of the invention may interact with one or more components and/or species of the electrochemical cell (e.g., a species, comprising a proton) to delay and/or prevent formation of the impurity and/or accumulation of the impurity on the surface of the anode, thereby reducing swelling. For example, the additive may bind to species comprising a proton, i.e., may act as a proton trap, thereby preventing formation of impurities. Use of additives and methods as described herein may improve the cycle life of the batteries.

In some embodiments, the additive may comprise an aromatic group. The aromatic group may typically have five or six ring atoms, or more. Examples of aromatic groups include benzene, naphthalene, and the like. The aromatic groups may be optionally substituted, for example, with one or more alkyl, heteroalkyl, alkenyl, heteroalkenyl, alkynyl, heteroalkynyl, heterocyclic, aryl, or heteroaryl groups. In some cases, the additive may be an aromatic group substituted by at least one alkyl group or substituted alkyl group. For example, the additive may be ethylbenzene, iso-propylbenzene, m-xylene, o-xylene, trifluoromethylbenzene, or the like.

In some cases, the aromatic group may be a polycyclic group comprising two or more fused rings. In some cases, the additive may comprise a compound comprising at least two, fused aromatic rings, wherein the compound is optionally substituted. Aromatic rings which are “fused” may comprise two or more ring atoms that are common to the two adjoining rings. In some cases, the two, fused aromatic rings may comprise two, adjacent ring atoms which are common between the two adjoining rings. For example, the additive may be naphthalene, or substituted derivatives thereof, such as; 1,8-bis(dimethylamino)naphthalene.

In some cases, the additive may be a compound comprising one or more heteroatoms. For example, the additive may be a heterocycle or heteroalkyl compound. In some cases, the additive may comprise one, two, or three heteroatoms, such as oxygen, nitrogen, sulfur, combinations thereof, or the like. In some cases, the additive may be a compound comprising at least one heteroatom ring atom. For example, the additive may be a six-membered aromatic ring comprising at least one nitrogen atom, excluding pyridine and pyridinium nitrate. In some embodiments, the additive may be a six-membered aromatic ring comprising two nitrogen atoms. The six-membered aromatic ring may be substituted and/or may be fused to additional rings. Examples of such additives include, but are not limited to, imidazole, N-vinylimidazole, hexamethylmelamine, 2,2′-dipyridine, 4,7-phenanthroline, pyrazine, pyrazine nitrate, pyridinium p-toluenesulfonate, pyridinium 3-nitrobenzenesulfonate, pyridinium trifluoromethanesulfonate, 2-vinylpyridine, 2,6-lutidine, or 2,6-lutidine nitrate.

The additive may also comprise heteroatoms within groups that are pendant to (e.g., bonded to) an aromatic ring. In some embodiments, the additive may comprise an aromatic compounds comprising at least one alkoxy group. Examples of such compounds include, but are not limited to, 1,3-dimethoxybenzene, 1,4-dimethoxybenzene, 1,2-dimethoxybenzene, methoxybenzene, ethoxybenzene, 4-methylanisole, methylbenzyl ether, and other aromatic ethers.

The additive may also be a substituted alkene or a substituted alkyne. The alkenes or alkynes may be substituted with, for example, one or more alkyl, heteroalkyl, alkenyl, heteroalkenyl, alkynyl, heteroalkynyl, heterocyclic, aryl, or heteroaryl groups. Such groups may be optionally substituted. Specific examples of include divinylbenzene, styrene, 4-methoxystyrene, octyne-4, diphenylacetylene, and the like.

In some cases, the additives described herein may be associated with a polymer. For example, the additives may be combined with a polymer molecule or may be bonded to a polymer molecule. In some cases, the additive may comprise a six-membered aromatic ring comprising at least one nitrogen atom, wherein the ring is covalently bonded to a polymer. In some embodiments, the polymer is poly(vinylpyridine), a substituted derivative thereof, or a co-polymer thereof. For example, the additive may be poly(4-vinylpyridine-co-styrene). Polymers suitable for use as additives in the invention include those which are substantially compatible with (e.g., miscible with) species and/or components of the electrochemical cell.

In some embodiments, the additive is selected from the group consisting of pyrazine, pyrazine nitrate, pyridinium p-toluenesulfonate, pyridinium 3-nitrobenzenesulfonate, pyridinium trifluoromethanesulfonate, 2,6-lutidine, 2,6-lutidine nitrate, 1,3-dimethoxybenzene, 1,4-dimethoxybenzene, ethoxybenzene, divinylbenzene, and naphthalene.

Some embodiments of the invention may provide electrochemical cells, comprising an anode comprising lithium, a cathode, and a non-aqueous electrolyte comprising at least one additive as described herein, wherein the electrochemical cell swells as a result of repeated charge and discharge of the cell, and the swelling may have a maximum swelling along a dimension of the electrochemical cell. That is, the electrochemical cell may swell in more than one dimension, but may undergo a maximum swelling along a particular dimension. The electrochemical cell may further comprise a housing compartment for the electrochemical cell, wherein the housing compartment is less than 10%, less than 5%, less than 3%, or, in some cases, less than 1% larger in size than the electrochemical cell, in the dimension of maximum swelling of the cell. This may advantageously allow for relatively smaller housing compartments for electrochemical cells, producing smaller, compact devices. Those of ordinary skill in the art would be able to select the appropriate housing compartment materials and characteristics (e.g., size, shape) suitable for use in a particular application.

In some embodiments, the invention provides methods for reduction of swelling in electrochemical cells. For example, an electrochemical cell may be provided, wherein the electrochemical cell comprises an anode with lithium as the active anode material, a cathode, and a non-aqueous electrolyte in electrochemical communication with the anode and cathode, wherein the electrolyte comprises at least one additive as described herein. The method may comprise cycling the cell, by alternately discharging and charging the cell, at least fifty times wherein, at the end of the 40^{th} cycle, the size of the cell increases by less than 20%, less than 15%, less than 10%, less than 5%, less than 3%, or, in some cases, less than 1%, as compared to an essentially identical cell over an essentially identical set of charge/discharge cycle absent the additive.

Suitable electroactive materials for use as cathode active materials in the cathode of the electrochemical cells of the invention include, but are not limited to, electroactive transition metal chalcogenides, electroactive conductive polymers, electroactive sulfur-containing materials, and combinations thereof. As used herein, the term “chalcogenides” pertains to compounds that contain one or more of the elements of oxygen, sulfur, and selenium. Examples of suitable transition metal chalcogenides include, but are not limited to, the electroactive oxides, sulfides, and selenides of transition metals selected from the group consisting of Mn, V, Cr, Ti, Fe, Co, Ni, Cu, Y, Zr, Nb, Mo, Ru, Rh, Pd, Ag, Hf, Ta, W, Re, Os, and Ir. In one embodiment, the transition metal chalcogenide is selected from the group consisting of the electroactive oxides of nickel, manganese, cobalt, and vanadium, and the electroactive sulfides of iron.

In one embodiment, a cathode includes one or more of the following materials: manganese dioxide, iodine, silver chromate, silver oxide and vanadium pentoxide, copper oxide, copper oxyphosphate, lead sulfide, copper sulfide, iron sulfide, lead bismuthate, bismuth trioxide, cobalt dioxide, copper chloride, manganese dioxide, and carbon. In another embodiment, the cathode active layer comprises: an electroactive conductive polymer. Examples of suitable electroactive conductive polymers include, but are not limited to, electroactive and electronically conductive polymers selected from the group consisting of polypyrroles, polyanilines, polyphenylenes, polythiophenes, and polyacetylenes. Examples of conductive polymers include polypyrroles, polyanilines, and polyacetylenes.

In some embodiments, electroactive materials for use as cathode active materials in electrochemical cells described herein include electroactive sulfur-containing materials. “Electroactive sulfur-containing materials,” as used herein, relates to cathode active materials which comprise the element sulfur in any form, wherein the electrochemical activity involves the oxidation or reduction of sulfur atoms or moieties. The nature of the electroactive sulfur-containing materials useful in the practice of this invention may vary widely, as known in the art. For example, in one embodiment, the electroactive sulfur-containing material comprises elemental sulfur. In another embodiment, the electroactive sulfur-containing material comprises a mixture of elemental sulfur and a sulfur-containing polymer. Thus, suitable electroactive sulfur-containing materials may include, but are not limited to, elemental sulfur and organic materials comprising sulfur atoms and carbon atoms, which may or may not be polymeric. Suitable organic materials include those further comprising heteroatoms, conductive polymer segments, composites, and conductive polymers.

Examples of sulfur-containing polymers include those described in: U.S. Pat. Nos. 5,601,947 and 5,690,702 to Skotheim et al.; U.S. Pat. Nos. 5,529,860 and 6,117,590 to Skotheim et al.; U.S. Pat. No. 6,201,100 issued Mar. 13, 2001, to Gorkovenko et al. of the common assignee, and PCT Publication No. WO 99/33130. Other suitable electroactive sulfur-containing materials comprising polysulfide linkages are described in U.S. Pat. No. 5,441,831 to Skotheim et al.; U.S. Pat. No. 4,664,991 to Perichaud et al., and in U.S. Pat. Nos. 5,723,230, 5,783,330, 5,792,575 and 5,882,819 to Naoi et al. Still further examples of electroactive sulfur-containing materials include those comprising disulfide groups as described, for example in, U.S. Pat. No. 4,739,018 to Armand et al.; U.S. Pat. Nos. 4,833,048 and 4,917,974, both to De Jonghe et al.; U.S. Pat. Nos. 5,162,175 and 5,516,598, both to Visco et al.; and U.S. Pat. No. 5,324,599 to Oyama et al.

In one embodiment, an electroactive sulfur-containing material of a cathode active layer comprises greater than 50% by weight of sulfur. In another embodiment, the electroactive sulfur-containing material comprises greater than 75% by weight of sulfur. In yet another embodiment, the electroactive sulfur-containing material comprises greater than 90% by weight of sulfur.

The cathode active layers of the present invention may comprise from about 20 to 100% by weight of electroactive cathode materials (e.g., as measured after an appropriate amount of solvent has been removed from the cathode active layer and/or after the layer has been appropriately cured). In one embodiment, the amount of electroactive sulfur-containing material in the cathode active layer is in the range of 5-30% by weight of the cathode active layer. In another embodiment, the amount of electroactive sulfur-containing material in the cathode active layer is in the range of 20% to 90% by weight of the cathode active layer.

Non-limiting examples of suitable liquid media (e.g., solvents) for the preparation of cathodes (as well as other components of cells described herein) include aqueous liquids, non-aqueous liquids, and mixtures thereof. In some embodiments, liquids such as, for example, water, methanol, ethanol, isopropanol, propanol, butanol, tetrahydrofuran, dimethoxyethane, acetone, toluene, xylene, acetonitrile, cyclohexane, and mixtures thereof can be used. Of course, other suitable solvents can also be used as needed.

Positive electrode layers may be prepared by methods known in the art. For example, one suitable method comprises the steps of: (a) dispersing or suspending in a liquid medium the electroactive sulfur-containing material, as described herein; (b) optionally adding to the mixture of step (a) a conductive filler and/or binder; (c) mixing the composition resulting from step (b) to disperse the electroactive sulfur-containing material; (d) casting the composition resulting from step (c) onto a suitable substrate; and (e) removing some or all of the liquid from the composition resulting from step (d) to provide the cathode active layer.

Suitable negative electrode materials for anode active layers: described herein include, but are not limited to, lithium metal such as lithium foil and lithium deposited onto a conductive substrate, and lithium alloys (e.g., lithium-aluminum alloys and lithium-tin alloys). While these are preferred negative electrode materials, the current collectors may also be used with other cell chemistries.

Methods for depositing a negative electrode material (e.g., an alkali metal anode such as lithium) onto a substrate may include methods such as thermal evaporation, sputtering, jet vapor deposition, and laser ablation. Alternatively, where the anode comprises a lithium foil, or a lithium foil and a substrate, these can be laminated together by a lamination process as known in the art to form an anode.

Positive and/or negative electrodes may optionally include one or more layers that interact favorably with a suitable electrolyte, such as those described in U.S. Provisional Application Ser. No. 60/872,939, filed Dec. 4, 2006 and entitled “Separation of Electrolytes,” by Mikhaylik et al., which is incorporated herein by reference in its entirety.

The electrolytes used in electrochemical or battery cells can function as a medium for the storage and transport of ions, and in the special case of solid electrolytes and gel electrolytes, these materials may additionally function as a separator between the anode and the cathode. Any liquid, solid, or gel material capable of storing and transporting ions may be used, so long as the material is electrochemically and chemically unreactive with respect to the anode and the cathode, and the material facilitates the transport of ions (e.g., lithium ions) between the anode and the cathode. The electrolyte is electronically non-conductive to prevent short circuiting between the anode and the cathode.

The electrolyte can comprise one or more ionic electrolyte salts to provide ionic conductivity and one or more liquid electrolyte solvents, gel polymer materials, or polymer materials. Suitable non-aqueous electrolytes may include organic electrolytes comprising one or more materials selected from the group consisting of liquid electrolytes, gel polymer electrolytes, and solid polymer electrolytes. Examples of non-aqueous electrolytes for lithium batteries are described by Dorniey in Lithium Batteries, New Materials, Developments and Perspectives, Chapter 4, pp. 137-165, Elsevier, Amsterdam (1994). Examples of gel polymer electrolytes and solid polymer electrolytes are described by Alamgir et al. in Lithium Batteries, New Materials, Developments and Perspectives, Chapter 3, pp. 93-136, Elsevier, Amsterdam (1994). Heterogeneous electrolyte compositions that can be used in batteries described herein are described in U.S. Provisional Application Ser. No. 60/872,939, filed Dec. 4, 2006.

Examples of useful non-aqueous liquid electrolyte solvents include, but are not limited to, non-aqueous organic solvents, such as, for example, N-methyl acetamide, acetonitrile, acetals, ketals, esters, carbonates, sulfones, sulfites, sulfolanes, aliphatic ethers, cyclic ethers, glymes, polyethers, phosphate esters, siloxanes, dioxolanes, N-alkylpyrrolidones, substituted forms of the foregoing, and blends thereof. Fluorinated derivatives of the foregoing are also useful as liquid electrolyte solvents.

In some cases, aqueous solvents can be used as electrolytes for lithium cells. Aqueous solvents can include water, which can contain other components such as ionic salts. As noted above, in some embodiments, the electrolyte can include species such as lithium hydroxide, or other species rendering the electrolyte basic, so as to reduce the concentration of hydrogen ions in the electrolyte.

Liquid electrolyte solvents can also be useful as plasticizers for gel polymer electrolytes, i.e., electrolytes comprising one or more polymers forming a semi-solid network. Examples of useful gel polymer electrolytes include, but are not limited to, those comprising one or more polymers selected from the group consisting of polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, derivatives of the foregoing, copolymers of the foregoing, crosslinked and network structures of the foregoing, and blends of the foregoing, and optionally, one or more plasticizers. In some embodiments, a gel polymer electrolyte comprises between 10-20%, 20-40%, between 60-70%, between 70-80%, between 80-90%, or between 90-95% of a heterogeneous electrolyte by volume.

In some embodiments, one or more solid polymers can be used to form an electrolyte. Examples of useful solid polymer electrolytes include, but are not limited to, those comprising one or more polymers selected from the group consisting of polyethers, polyethylene oxides, polypropylene oxides, polyimides, polyphosphazenes, polyacrylonitriles, polysiloxanes, derivatives of the foregoing, copolymers of the foregoing, crosslinked and network structures of the foregoing, and blends of the foregoing.

In addition to electrolyte solvents, gelling agents, and polymers as known in the art for forming electrolytes, the electrolyte may further comprise one or more ionic electrolyte salts, also as known in the art, to increase the ionic conductivity.

Examples of ionic electrolyte salts for use in the electrolytes of the present invention include, but are not limited to, LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, and LiN(SO₂CF₃)₂. Other electrolyte salts that may be useful include lithium polysulfides (Li₂Sₓ), and lithium salts of organic ionic polysulfides (LiSₓR)ₙ, where x is an integer from 1 to 20, n is an integer from 1 to 3, and R is an organic group, and those disclosed in U.S. Pat. No. 5,538,812 to Lee et al.

In some embodiments, electrochemical cells may further comprise a separator interposed between the cathode and anode. The separator may be a solid non-conductive or insulative material which separates or insulates the anode and the cathode from each other preventing short circuiting, and which permits the transport of ions between the anode and the cathode.

The pores of the separator may be partially or substantially filled with electrolyte. Separators may be supplied as porous free standing films which are interleaved with the anodes and the cathodes during the fabrication of cells. Alternatively, the porous separator layer may be applied directly to the surface of one of the electrodes, for example, as described in PCT Publication No. WO 99/33125 to Carlson et al. and in U.S. Pat. No. 5,194,341 to Bagley et al.

A variety of separator materials are known in the art. Examples of suitable solid porous separator materials include, but are not limited to, polyolefins, such as, for example, polyethylenes and polypropylenes, glass fiber filter papers, and ceramic materials. Further examples of separators and separator materials suitable for use in this invention are those comprising a microporous xerogel layer, for example, a microporous pseudo-boehmite layer, which may be provided either as a free standing film or by a direct coating application on one of the electrodes, as described in U.S. Pat. Nos. 6,153,337 and 6,306,545 by Carlson et al. of the common assignee. Solid electrolytes and gel electrolytes may also function as a separator in addition to their electrolyte function.

In the compounds and compositions of the invention, the term “alkyl” refers to the radical of saturated aliphatic groups, including straight-chain alkyl groups, branched-chain alkyl groups, cycloalkyl (alicyclic) groups, alkyl substituted cycloalkyl groups, and cycloalkyl substituted alkyl groups. The alkyl groups may be optionally substituted with additional groups, as described further below. In some embodiments, a straight chain or branched chain alkyl may have 30 or fewer carbon atoms in its backbone, and, in some cases, 20 or fewer. In some embodiments, a straight chain or branched chain alkyl has 12 or fewer carbon atoms in its backbone (e.g., C₁-C₁₂ for straight chain, C₃-C₁₂ for branched chain), 6 or fewer, or, 4 or fewer. In some embodiments, cycloalkyls may have from 3-10 carbon atoms in their ring structure, or 5, 6 or 7 carbons in the ring structure. Examples of alkyl groups include, but are not limited to, methyl, ethyl, propyl, isopropyl, cyclopropyl, butyl, isobutyl, tert-butyl, cyclobutyl, hexyl, cyclochexyl, and the like.

The term “heteroalkyl” refers to an alkyl group as described herein in which one or more carbon atoms is replaced by a heteroatom. Suitable heteroatoms include oxygen, sulfur, nitrogen, phosphorus, and the like. Examples of heteroalkyl groups include, but are not limited to, alkoxy, amino, thioester, and the like.

The terms “alkene” and “alkyne” refer to unsaturated aliphatic groups analogous in length and possible substitution to the alkyls described above, but that contain at least one double or triple bond respectively.

The terms “heteroalkenyl” and “heteroalkynyl” refer to unsaturated aliphatic groups analogous in length and possible substitution to the heteroalkyls described above, but that contain at least one double or triple bond respectively.

As used herein, the term “halogen” or “halide” designates —F, —Cl, —Br or —I.

The term “methyl” refers to the monovalent radical —CH₃, and the term “methoxy” refers to the monovalent radical —OCH₃.

The term “aromatic” is given its ordinary meaning in the art and refers to cyclic groups comprising a conjugated pi electron system.

The term “aryl” refers to aromatic carbocyclic groups, optionally substituted, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated pi electron system, while other, adjoining rings can be cycloalkyls, cycloalkenyls, cycloalkynyls, aryls and/or heterocyclyls. The aryl group may be optionally substituted, as described herein. “Carbocyclic aryl groups” refer to aryl groups wherein the ring atoms on the aromatic ring are carbon atoms. Carbocyclic aryl groups include monocyclic carbocyclic aryl groups and polycyclic or fused compounds (e.g., two or more adjacent ring atoms are common to two adjoining rings) such as naphthyl groups.

The terms “heteroaryl” refers to aryl groups comprising at least one heteroatom as a ring atom.

The term “heterocycle” refers to cyclic groups containing at least one heteroatom as a ring atom, in some cases, 1 to 3 heteroatoms as ring atoms, with the remainder of the ring atoms being carbon atoms. Suitable heteroatoms include oxygen, sulfur, nitrogen, phosphorus, and the like. In some cases, the heterocycle may be 3- to 10-membered ring structures, or 3- to 7-membered rings, whose ring structures include one to four heteroatoms. The term “heterocycle” may include heteroaryl groups, saturated heterocycles (e.g., cycloheteroalkyl) groups, or combinations thereof. The heterocycle may be a saturated molecule, or may comprise one or more double bonds. In some case, the heterocycle is a nitrogen heterocycle, wherein at least one ring comprises at least one nitrogen ring atom. The heterocycles may be fused to other rings to form a polycylic heterocycle. The heterocycle may also be fused to a spirocyclic group. In some cases, the heterocycle may be attached to a molecule (e.g., a polymer) via a nitrogen or a carbon atom in the ring.

Heterocycles include, for example, thiophene, benzothiophene, thianthrene, furan, tetrahydrofuran, pyran, isobenzofuran, chromene, xanthene, phenoxathiin, pyrrole, dihydropyrrole, pyrrolidine, imidazole, pyrazole, pyrazine, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, triazole, tetrazole, oxazole, isoxazole, thiazole, isothiazole, phenanthridine, acridine, pyrimidine, phenanthroline, phenazine, phenarsazine, phenothiazine, furazan, phenoxazine, pyrrolidine, oxolane, thiolane, oxazole, oxazine, piperidine, homopiperidine (hexamethyleneimine), piperazine (e.g., N-methyl piperazine), morpholine, lactones, lactams such as azetidinones and pyrrolidinones, sultams, sultones, other saturated and/or unsaturated derivatives thereof, and the like. The heterocyclic ring can be optionally substituted at one or more positions with such substituents as described herein.

The term “alkoxy” refers to the group, O-alkyl.

The terms “amine” and “amino” are art-recognized and refer to both unsubstituted and substituted amines, e.g., a moiety that can be represented by the general formula: N(R′)(R″)(R′″) wherein R′, R″, and R′″ each independently represent a group permitted by the rules of valence.

The terms “ortho” (or “o-”), “meta” (or “m-”) and “para” (or “p-”) apply to 1,2-, 1,3- and 1,4-disubstituted benzenes, respectively. For example, the names 1,2-dimethylbenzene, ortho-dimethylbenzene, and o-dimethylbenzene are synonymous.

As used herein, the term “substituted” is contemplated to include all permissible substituents of organic compounds, “permissible” being in the context of the chemical rules of valence known to those of ordinary skill in the art. It will be understood that “substituted” also includes that the substitution results in a stable compound, e.g., which does not spontaneously undergo transformation such as by rearrangement, cyclization, elimination, etc. In some cases, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl” group must still comprise the phenyl moiety and can not be modified by substitution, in this definition, to become, e.g., a pyridine ring. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, aryl, aryloxy, perhaloalkoxy, aralkoxy, heteroaryl, heteroaryloxy, heteroarylalkyl, heteroaralkoxy, azido, amino, halide, alkylthio, oxo, acylalkyl, carboxy esters, -carboxamido, acyloxy, aminoalkyl, alkylaminoaryl, alkylaryl, alkylaminoalkyl, alkoxyaryl, arylamino, aralkylamino, alkylsulfonyl, -carboxamidoalkylaryl, -carboxamidoaryl, hydroxyalkyl, haloalkyl, alkylaminoalkylcarboxy-, aminocarboxamidoalkyl-, cyano, alkoxyalkyl, perhaloalkyl, arylalkyloxyalkyl, and the like.

The figures that accompany this disclosure are schematic only, and illustrate a substantially flat battery arrangement. It is to be understood that any electrochemical cell arrangement can be constructed, employing the principles of the present invention, in any configuration. For example, additional configurations are described in U.S. patent application Ser. No. 11/400,025, filed Apr. 6, 2006, entitled, “Electrode Protection in both Aqueous and Non-Aqueous Electrochemical Cells, including Rechargeable Lithium Batteries,” to Affinito et al., which is incorporated herein by reference in its entirety.

### EXAMPLES

### Example 1

This example describes a protocol for preparing an electrochemical cell comprising a Li anode, a sulfur cathode, a porous separator, and an electrolyte, according to one embodiment of the invention.

To prepare the cathode, a mixture of 73 wt % of elemental sulfur, 16 wt % of a first conductive carbon pigment, Carbon XE2, 6 wt % of a second conductive pigment, Ketjenblack®, and 5 wt % of polyethylene powder (grade T1000) dispersed in isopropanol was coated onto both sides of a 6 micron thick carbon-coated aluminum/PET substrate. After drying the coated cathode, the thickness of the film was measured to be about 100 microns, the film being 1549 mm in length and 36.83 mm in width. The sulfur surface loading was 1.58 mg/cm². The anode used was metallic Li foil, with a total anode thickness of 50 microns, the anode being 1626 mm in length and 41.91 mm in width. The porous separator used was 9 micron Tonen (Tonen Chemical Corporation, Japan).

In this example, the electrolyte (Electrolyte 1) was prepared by combining 16.99 wt % lithium bis(trifluoromethanesulfoneimide), 4.08 wt % LiNO₃, 39.46 wt % 1,2-dimethoxyethane, 39.46 wt % 1,3-dioxolane, and various additives comprising a six-membered aromatic rings with a nitrogen atom at concentration of 0.07 M (Electrolyte 1), as shown in Table 1.

The above components were combined into a layered structure of cathode/separator/anode, which was wound and compressed into a jellyroll, with the liquid electrolyte filling the void areas of the separator and cathode to form prismatic cells. Cathode and anode contacts were then attached to the finished jellyroll by a metal-spray technique. The jellyrolls were placed into soft multi-layer packages filled with 7.6 g of liquid electrolyte and thermally sealed. Prismatic cell mass was about 15.5 g.

The cells were discharged at 500 mA to 1.7 V and charged at 315 mA to 2.5 V. Cell capacity was about 2200 mAh. The thickness of the cells was measured during cycling, and the results are shown in Table 1.

TABLE 1
Swelling behavior of cells with additives comprising a six-membered
aromatic rings with N-atom.

| | Cell | | Thickness | |
|---|---|---|---|---|
| | thickness, mm | | change | |
| Electrolyte Additive (0.07 M) | 0 cycles | 50 cycles | mm | % |
| Control (No additive) | 11.3 | 17.6 | 6.3 | 55.8 |
| Poly(4-vinylpyridine-co-styrene) | 10.85 | 16.66 | 5.81 | 53.5 |
| hexamethylmelamine | 11.4 | 14.2 | 2.8 | 24.6 |
| 2,2′-Dipyridyl | 10.82 | 12.85 | 2.03 | 18.8 |
| 4,7-Phenanthroline | 11.49 | 12.66 | 1.17 | 10.2 |
| Pyrazine | 11.23 | 11.98 | 0.75 | 6.7 |
| Pyridinium p-toluenesulfonate | 11 | 11.3 | 0.3 | 2.7 |
| Pyridinium 3- | 10.97 | 11.23 | 0.26 | 2.4 |
| nitrobenzenesulfonate | | | | |
| Pyridinium | 11.1 | 11.26 | 0.16 | 1.4 |
| Trifluoromethanesulfonate | | | | |
| 2,6-Lutidine | 11.58 | 11.64 | 0.06 | 0.5 |
| Pyrazine Nitrate | 11.55 | 11.55 | 0 | 0.0 |
| 2,6-Lutidine Nitrate | 11.83 | 11.47 | −0.36 | −3.0 |

### Example 2

A prismatic cell containing a cathode, anode, and porous separator were fabricated using the method described in Example 1.

In this example, the electrolyte (Electrolyte 2) was prepared by combining 4 wt % lithium bis(trifluoromethanesulfoneimide), 3.77 wt % LiNO₃, 42.52 wt % 1,2-dimethoxyethane, 42.52 wt % 1,3-dioxolane, 1 wt % guanidine nitrate, 6.2 wt % Li₂S₈, and various additives were added at concentrations of 2-10 wt %, as shown in Tables 2-5.

The cells were discharged at 500 mA to 1.7 V and charged at 315 mA to 2.5 V. Cell capacity was about 2600-2700 mAh. The thickness of the cells was measured during cycling, and the results are shown in Tables 2-5.

TABLE 2
Swelling behavior of cells with additives comprising aromatic ethers or
aromatic compounds with alkoxy group.

| | | Cell Thickness, | | |
|---|---|---|---|---|
| | | mm | | Thickness |
| Electrolyte Additive | Additive wt % | 4 cycles | 40 cycles | change |
| Control (No additive) | 0 | 12.95 | 16.66 | 29% |
| 1,3-Dimethoxybenzene | 10 | 10.45 | 11.47 | 10% |
| 1,3-Dimethoxybenzene | 5 | 10.44 | 10.90 | 4% |
| 1,4-Dimethoxybenzene | 2 | 11.01 | 12.68 | 15% |
| 1,4-Dimethoxybenzene | 5 | 10.46 | 11.12 | 6% |
| 1,2-Dimethoxybenzene | 5 | 10.16 | 11.47 | 13% |
| Methoxybenzene | 2 | 10.79 | 11.97 | 11% |
| Ethoxybenzene | 10 | 10.33 | 10.91 | 6% |
| Ethoxybenzene | 5 | 10.40 | 10.77 | 4% |
| 4-Methylanisole | 5 | 11.02 | 12.61 | 14% |

TABLE 3
Swelling behavior of cells with additives comprising aromatic compounds
with alkyl or substituted alkyl group

| | | Cell Thickness, | | |
|---|---|---|---|---|
| | | mm | | |
| | | | 40 | Thickness |
| Electrolyte Additive | Additive wt % | 4 cycles | cycles | change |
| Control (No additive) | 0 | 12.95 | 16.66 | 29% |
| Ethylbenzene | 5 | 13.04 | 15.23 | 17% |
| iso-Propylbenzene | 2 | 14.15 | 16.39 | 16% |
| iso-Propylbenzene | 5 | 12.77 | 14.29 | 12% |
| m-Xylene | 5 | 13.03 | 15.85 | 22% |
| o-Xylene | 2 | 13.48 | 15.60 | 16% |
| o-Xylene | 5 | 13.68 | 16.51 | 21% |
| Methylbenzyl ether | 2 | 10.68 | 11.97 | 12% |
| Methylbenzyl ether | 5 | 10.73 | 12.64 | 18% |
| Trifluoromethylbenzene | 2 | 10.38 | 11.79 | 14% |
| Trifluoromethylbenzene | 5 | 10.16 | 11.85 | 17% |

TABLE 4
Swelling behavior of cells with additives comprising substituted alkenes or
alkynes.

| | | Cell Thickness, | | |
|---|---|---|---|---|
| | | mm | | Thickness |
| Electrolyte Additive | Additive wt % | 4 cycles | 40 cycles | change |
| Control (No additive) | 0 | 12.95 | 16.66 | 29% |
| Divinylbenzene | 2 | 10.75 | 11.71 | 9% |
| Octyne-4 | 2 | 11.80 | 13.15 | 11% |
| Diphenylacetylene | 2 | 11.40 | 12.55 | 10% |
| Styrene | 2 | 10.33 | 11.39 | 10% |
| 4-MethoxyStyrene | 2 | 10.65 | 11.8 | 11% |

TABLE 5
Swelling behavior of cells with additives comprising polycyclic aromatic
compounds, optionally substituted.

| | | Cell Thickness, | | |
|---|---|---|---|---|
| | | mm | | Thickness |
| Electrolyte Additive | Additive wt % | 4 cycles | 40 cycles | change |
| Control (No additive) | 0 | 12.95 | 16.66 | 29% |
| Naphthalene | 2 | 11.20 | 11.57 | 3% |
| 1,8-bis(Dimethyl- | 2 | 10.10 | 12.80 | 27% |
| amino)naphthalene | | | | |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in: other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed:

1. An electrochemical cell, comprising:
an anode comprising lithium;
a cathode; and
a non-aqueous electrolyte comprising at least one additive selected from the group consisting of six-membered aromatic rings comprising at least one nitrogen atom, excluding pyridine and pyridinium nitrate; six-membered aromatic rings comprising two nitrogen atoms; aromatic compounds comprising at least one alkoxy group or an optionally substituted alkyl group; substituted alkenes; substituted alkynes; and compounds comprising at least two, fused aromatic rings, optionally substituted.

2. An electrochemical cell as in claim 1, wherein the at least one additive is selected from the group consisting of hexamethylmelamine, 2,2′-dipyridine, 4,7-phenanthroline, pyrazine, pyrazine nitrate, pyridinium p-toluenesulfonate, pyridinium 3-nitrobenzenesulfonate, pyridinium trifluoromethanesulfonate, 2-vinylpyridine, 2,6-lutidine, 2,6-lutidine nitrate, 1,3-dimethoxybenzene, 1,4-dimethoxybenzene, 1,2-dimethoxybenzene, methoxybenzene, ethoxybenzene, 4-methylanisole, ethylbenzene, iso-propylbenzene, m-xylene, o-xylene, methylbenzyl ether, trifluoromethylbenzene, divinylbenzene, octyne-4, diphenylacetylene, styrene, 4-methoxystyrene, naphthalene, and 1,8-bis(dimethylamino)naphthalene.

3. An electrochemical cell as in claim 1, wherein the at least one additive is selected from the group consisting of pyrazine, pyrazine nitrate, pyridinium p-toluenesulfonate, pyridinium 3-nitrobenzenesulfonate, pyridinium trifluoromethanesulfonate, 2,6-lutidine, 2,6-lutidine nitrate, 1,3-dimethoxybenzene, 1,4-dimethoxybenzene, ethoxybenzene, divinylbenzene, and naphthalene.

4. An electrochemical cell as in claim 1, wherein the six-membered aromatic ring comprising at least one nitrogen atom is covalently bonded to a polymer.

5. An electrochemical cell as in claim 4, wherein the polymer is poly(vinylpyridine), a substituted derivative thereof, or a co-polymer thereof.

6. An electrochemical cell as in claim 4, wherein the polymer is poly(4-vinylpyridine-co-styrene).

7. An electrochemical cell as in claim 1, wherein the additive is added in an amount sufficient to inhibit swelling in the cell by at least 10% over 50 charge/discharge cycles of the cell, as compared to swelling of an essentially identical cell over an essentially identical set of charge/discharge cycles, absent the additive.

8. An electrochemical cell as in claim 1, wherein the additive is added in an amount sufficient to inhibit swelling in the cell by at least 25% over 50 charge/discharge cycles of the cell, as compared to swelling of an essentially identical cell over an essentially identical set of charge/discharge cycles, absent the additive.

9. An electrochemical cell as in claim 1, wherein the additive is added in an amount sufficient to inhibit swelling in the cell by at least 50% over 50 charge/discharge cycles of the cell, as compared to swelling of an essentially identical cell over an essentially identical set of charge/discharge cycles, absent the additive.

10. An electrochemical cell as in claim 1, wherein the additive is added in an amount sufficient to inhibit swelling in the cell by at least 75% over 50 charge/discharge cycles of the cell, as compared to swelling of an essentially identical cell over an essentially identical set of charge/discharge cycles, absent the additive.

11. An electrochemical cell as in claim 1, wherein the additive is added in an amount sufficient to inhibit swelling in the cell by 100% over 50 charge/discharge cycles of the cell, as compared to swelling of an essentially identical cell over an essentially identical set of charge/discharge cycles, absent the additive.

12. An electrochemical device, comprising:
an electrochemical cell, comprising an anode comprising lithium, a cathode, and a non-aqueous electrolyte comprising at least one additive selected from the group consisting of six-membered aromatic rings comprising at least one nitrogen atom, excluding pyridine and pyridinium nitrate; six-membered aromatic rings comprising two nitrogen atoms; aromatic compounds comprising at least one alkoxy group or an optionally substituted alkyl group; substituted alkenes; substituted alkynes; and compounds comprising at least two, fused aromatic rings, optionally substituted, wherein the electrochemical cell swells as a result of repeated charge and discharge of the cell, said swelling having a maximum swelling along a dimension of the electrochemical cell; and
a housing compartment for the electrochemical cell, wherein the housing compartment is less than 10% larger in size than the electrochemical cell in the dimension of the electrochemical cell.

13. An electrochemical device as in claim 12, wherein the housing compartment is less than 5% larger in size than the electrochemical cell in the dimension of the electrochemical cell.

14. An electrochemical device as in claim 12, wherein the housing compartment is less than 3% larger in size than the electrochemical cell in the dimension of the electrochemical cell.

15. An electrochemical device as in claim 12, wherein the housing compartment is less than 1% larger in size than the electrochemical cell in the dimension of the electrochemical cell.

16. An electrochemical device as in claim 12, wherein the at least one additive is selected from the group consisting of hexamethylmelamine, 2,2′-dipyridine, 4,7-phenanthroline, pyrazine, pyrazine nitrate, pyridinium p-toluenesulfonate, pyridinium 3-nitrobenzenesulfonate, pyridinium trifluoromethanesulfonate, 2-vinylpyridine, 2,6-lutidine, 2,6-lutidine nitrate, 1,3-dimethoxybenzene, 1,4-dimethoxybenzene, 1,2-dimethoxybenzene, methoxybenzene, ethoxybenzene, 4-methylanisole, ethylbenzene, iso-propylbenzene, m-xylene, o-xylene, methylbenzyl ether, trifluoromethylbenzene, divinylbenzene, octyne-4, diphenylacetylene, styrene, 4-methoxystyrene, naphthalene, and 1,8-bis(dimethylamino)naphthalene.

17. An electrochemical cell as in claim 12, wherein the at least one additive is selected from the group consisting of pyrazine, pyrazine nitrate, pyridinium p-toluenesulfonate, pyridinium 3-nitrobenzenesulfonate, pyridinium trifluoromethanesulfonate, 2,6-lutidine, 2,6-lutidine nitrate, 1,3-dimethoxybenzene, 1,4-dimethoxybenzene, ethoxybenzene, divinylbenzene, and naphthalene.

18. A method, comprising:
providing an electrochemical cell comprising an anode with lithium as the active anode material, a cathode, and a non-aqueous electrolyte in electrochemical communication with the anode and cathode, wherein the electrolyte comprises at least one additive selected from the group consisting of six-membered aromatic rings comprising at least one nitrogen atom, excluding pyridine and pyridinium nitrate; six-membered aromatic rings comprising two nitrogen atoms; aromatic compounds comprising at least one alkoxy group or an optionally substituted alkyl group; substituted alkenes; substituted alkynes; and compounds comprising at least two, fused aromatic rings, optionally substituted; and
cycling the cell, by alternatively discharging and charging the cell, at least fifty times wherein, at the end of the 40^{th} cycle, the size of the cell increases by less than 20% as compared to an essentially identical cell over an essentially identical set of charge/discharge cycle absent the additive.

19. A method as in claim 18, wherein, at the end of the 40^{th} cycle, the size of the cell increases by less than 15% as compared to an essentially identical cell over an essentially identical set of charge/discharge cycle absent the additive.

20. A method as in claim 18, wherein, at the end of the 40^{th} cycle, the size of the cell increases by less than 10% as compared to an essentially identical cell over an essentially identical set of charge/discharge cycle absent the additive.

21. A method as in claim 18, wherein, at the end of the 40^{th} cycle, the size of the cell increases by less than 5% as compared to an essentially identical cell over an essentially identical set of charge/discharge cycle absent the additive.

22. A method as in claim 18, wherein, at the end of the 40^{th} cycle, the size of the cell increases by less than 3% as compared to an essentially identical cell over an essentially identical set of charge/discharge cycle absent the additive.

23. A method as in claim 18, wherein, at the end of the 40^{th} cycle, the size of the cell increases by less than 1% as compared to an essentially identical cell over an essentially identical set of charge/discharge cycle absent the additive.

24. A method as in claim 18, wherein the at least one additive is selected from the group consisting of hexamethylmelamine, 2,2′-dipyridine, 4,7-phenanthroline, pyrazine, pyrazine nitrate, pyridinium p-toluenesulfonate, pyridinium 3-nitrobenzenesulfonate, pyridinium trifluoromethanesulfonate, 2-vinylpyridine, 2,6-lutidine, 2,6-lutidine nitrate, 1,3-dimethoxybenzene, 1,4-dimethoxybenzene, 1,2-dimethoxybenzene, methoxybenzene, ethoxybenzene, 4-methylanisole, ethylbenzene, iso-propylbenzene, m-xylene, o-xylene, methylbenzyl ether, trifluoromethylbenzene, divinylbenzene, octyne-4, diphenylacetylene, styrene, 4-methoxystyrene, naphthalene, and 1,8-bis(dimethylamino)naphthalene.

25. A method as in claim 18, wherein the at least one additive is selected from the group consisting of pyrazine, pyrazine nitrate, pyridinium p-toluenesulfonate, pyridinium 3-nitrobenzenesulfonate, pyridinium trifluoromethanesulfonate, 2,6-lutidine, 2,6-lutidine nitrate, 1,3-dimethoxybenzene, 1,4-dimethoxybenzene, ethoxybenzene, divinylbenzene, and naphthalene.
